(19) United States
(12) Patent Application Publication
(10) Pub. No.: US 2013/0124973 A1
(43) Pub. Date: May 16, 2013

(54) Automatic Diary for an Electronic Device

(71) Applicant: Gregory Alexander Piccionelli, Westlake Village, CA (US)

(72) Inventor: Gregory Alexander Piccionelli, Westlake Village, CA (US)

(21) Appl. No.: 13/668,304

(22) Filed: Nov. 4, 2012

Related U.S. Application Data
(60) Provisional application No. 61/628,738, filed on Nov. 4, 2011.
(60) Provisional application No. 61/612,192, filed on Mar. 16, 2012.
(60) Provisional application No. 61/722,124, filed on Nov. 2, 2012.

(51) Int. Cl. G06F 17/22

(52) U.S. Cl. CPC G06F 17/2247
USPC 715/234

(57) ABSTRACT

An Automatic Diary System (“ADS”) for an electronic device comprising a personal aggregation module, a page generation module, and an output module. The personal aggregation module may be configured to receive input data from a data input module and at least one other module and, in response, produce aggregation data. The at least one other module may be a time module, voicemail module, Internet module, multimedia module, or sensor module. The page generation module may be configured to create electronic pages of organized data from the aggregation data received from the personal aggregation module, and the output module may be configured to display the electronic pages to a user of the electronic device, and to store all or a portion of the electronic pages on the electronic device, and also to transmit the electronic pages either to servers via the Internet or directly to other electronic devices.

### RELATED APPLICATION(S)

This application claims priority of U.S. Provisional Patent Application Ser. No. 61/628,738, filed on Nov. 4, 2011, entitled “AUTOMATIC ON-LINE DIARY,” U.S. Provisional Patent Application Ser. No. 61/612,192, filed on Mar. 16, 2012, entitled “AUTOMATIC DIARY FOR AN ELECTRONIC DEVICE,” and U.S. Provisional Patent Application Ser. No. 61/722,124, filed on Nov. 2, 2012, entitled “MORE DETAILS AND FURTHER EXPLANATION REGARDING THE ONLINE DIARY”, all three of which applications are incorporated in their entireties in this application by this reference.

### BACKGROUND OF THE INVENTION

1. Field of the Invention

The present invention relates generally to systems and methods for automatically generating a diary on an electronic device.

2. Related Art

The use of telecommunication devices has grown at a rapid pace within modern society. Additionally, these telecommunication devices have increased in power and complexity and have rapidly merged with computing technologies. At present, these telecommunication devices include mobile computing and communication devices such as, for example, portable computers (both laptop and notebook), personal computing tablets (such as, for example, an Apple IPad®, Samsung Galaxy®, Toshiba Thrive, Motorola XOOM®, ASUS Eee Pad, Amazon Kindle®, etc.), smartphones (such as, for example, an Apple IPhone® or other devices utilizing operating systems from Google®, Microsoft®, Nokia, RIM, Linux, etc.), and portable media players with network connectivity (such as, for example, an Apple IPod®, Sony Walkman®, Creative Labs ZEN®, or other similar devices), etc.

Many of these telecommunication devices are mobile devices that include, for example, a Global Positioning System (“GPS”) receiver, Bluetooth® transceiver, cellular telephone transceiver, Wi-Fi® transceiver, an Ethernet transceiver, a microprocessor, memory, resident software, user input devices (such as touchpads, keyboards, video and still cameras, speaker, microphone, and display screen). As such, these telecommunication devices afford users a variety of information-processing and content-generating applications.

Many of these telecommunication devices allow the user to produce data files (“Data Files” or “PRDFs”) including, without limitation, personal memoranda, e-mail messages, recordings of voice-mail messages, recordings of video messages, still photos, videos, audio recordings, notes, texts, tweets, Web pages, Internet searches made by the user, Internet search results provided to the user, online payment information provided by the user, information about products and services received by the user, electronic tickets, electronic coupons, UPC code data, Q-code scan data, data regarding redeemed tickets, data regarding redeemed coupons, maps and other data associated with the user's present or past location, data associated with the user's playing of games (e.g., online games), data that the user has inputted on websites, data associated with the user's web browsing (e.g., cookies, etc.), data regarding phone calls the user has made and received, recordings of voice mail messages, recordings of video mail messages, and data associated with haptic information created or received by the user, etc. audio recordings, notes, texts, web pages, Internet search results, payment information, information about products and services purchased, tickets, coupons, data regarding redeemed tickets and coupons, maps and other data associated with the user's present or past location, data associated with the playing of games, data inputted on websites, data associated with web browsing, such as cookies, data regarding phone calls made and received, and data associated with haptic information generated or received by the user, etc. Certain of these devices further allow the user to transmit data files over networks (such as, for example, the Internet, PCS network, cellular network, etc.) and to post messages and other content on sites such as social networking sites, for example, Facebook®, Twitter®, LinkedIn®, and Stage32™ Since many of these telecommunication devices are equipped with locational sensors, such as GPS receivers, they enable a user to determine his or her location at any time.

In addition to conventional use of their telecommunication devices, many people desire to keep a diary that documents their daily lives. Use of telecommunication devices often involves the acquisition of data regarding a user. For example, data regarding online searches conducted by a user (e.g., what terms are used, where the user is located at the time of the search, device used, etc.) is often kept by online search engine service providers and data associated with the online purchase of products and services. Because today's telecommunication devices are used in the creation and/or use of data files of the types exemplified above, they afford their users the opportunity to document many aspects of their lives, such as where they have been, what phone, text, and email messages they have received or sent, what they have electronically purchased, what photos and videos they have taken, and where they took them, what notes and other recordings they made on their device, and where they made them, who they have been in proximity to, what online searches they have performed, and what Web sites they have visited and/or interacted with using one or more of the applications that are involved in the generation of data and data files discussed above. However, creating and maintaining a diary can be time-consuming and tedious, especially if a large quantity of content, in multiple formats, is generated. As an example, even daily updating of a single page on a social network had recently drawn complaints from users, who find that they are lacking in the discipline required for the task, or otherwise unable to keep up with the amount of information that must be processed and posted.

Therefore, a need exists for a system and method that facilitates the production and maintenance of a user's aggregated electronic information into an online diary on, or accessible from, an electronic device such as, for example, a telecommunication device, or on or accessible from a network, such as a cloud computing network, where such data is accessible by one or more electronic devices. A need also exists for systems and methods that facilitate incorporation of multiple data files generated by different applications into an integrated diary for an electronic device or accessible by one or more electronic devices from a network or plurality of networks.

Additionally, there is also a need for systems and methods whereby multiple users are able to share and compare their aggregated electronic information in their respective online diaries with other users, based on commonalities in the aggregated electronic information, as desired and determined by each of the individual users. Moreover, it is also advantageous to make available the aggregated electronic information of multiple users for commercial purposes, whereby advertisements, electronic coupons, notices, and other commercial communications may be selectively transmitted to the multiple users based on the aggregated electronic information associated with a user.

### SUMMARY OF THE INVENTION

To address the foregoing problems, in whole or in part, and/or other problems that may have been observed by persons skilled in the art, the present disclosure provides methods, processes, systems, apparatus, instruments, and/or devices, as described by way of example in implementations set forth below.

An Automatic Diary System (“ADS”) for an electronic device is described. The ADS may include a personal aggregation module, a page generation module in signal communication with the personal aggregation module, and an output module in signal communication with the page generation module.

The personal aggregation module may be configured to receive input data from a data input module and at least a second module and, in response, produce aggregation data. The second module may be a time module, voicemail module, Internet module, multimedia module, or sensor module. The page generation module may be configured to create an electronic page of organized data in response to receiving the aggregation data from the personal aggregation module; and the output module may be configured to either display the electronic page of organized data on a display or to send the electronic page of organized data, or part(s) thereof, to an Internet module that is configured to transmit the electronic page of organized data to the Internet.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

It is to be understood that the following description of various examples is given only for the purpose of illustration and is not to be taken in a limiting sense. The partitioning of examples in the function blocks, modules or units shown in the drawings is not to be construed as indicating that these function blocks, modules or units are necessarily implemented as physically separate units. Functional blocks, modules or units shown or described may be implemented as separate units, circuits, chips, functions, modules, or circuit elements. One or more functional blocks or units may also be implemented in a common circuit, chip, circuit element or unit, or other function blocks, modules, or units.

FIG. 1 is block diagram of an example of an implementation of an Automatic Diary System (“ADS”) for use in an electronic device in accordance with the present invention.

FIG. 2 is a schematic representation of an embodiment of a system and method according to the present invention, in which data files generated by a plurality of applications are (i) provided to one or more sites on a network; (ii) accessed on one or more remote computers; or (iii) a combination of (i) and (ii), and then integrated into one or more pages sorted by time of production (e.g., date or another quantum of time, such as a week, an hour, or a specified time range). Optional mapping functions and publication options are also provided to the user.

FIG. 3 is a flowchart illustrating an example of an implementation of a method of the present invention in which data files (“PRDF's”, or Personal Record Data Files), are created, transmitted to a site or application (“Personal Aggregation Site”), and combined into a file or set of files for a specified time frame (day, week, hour, etc.) (“DF”, or Diary File). Access to the DF is provided, and the user is afforded the opportunity to view selected DF's, and if desired, to publish some or all of the selected DF's to an external site, such as a social networking site. In some embodiments the data in the DFs is used to compare the data to the data in the DFs associated with one or more other users to determine commonalities that can then be displayed to one or more users.

FIG. 4 is a flowchart illustrating a more specific exemplary embodiment in which the user's daily travel record is displayed, and the user is enabled to view one or more PRDF's pertaining to selected locations at which the user was present on the specified date.

FIG. 5 is an illustration of an example of a DF for a selected date, produced according to embodiments of methods of the invention, that may be displayed to a user. The DF presented to the user includes windows listing various classes of PRDF's produced during the selected date, and also displays a map displaying the locations visited by the user during the selected date, with icons indicating the locations at which the listed PRDF's were produced.

FIGS. 6A, 6B, 6C, and 6D are illustrations showing an example of an implementation of the animated travel record (“ATR”) referred to in block 420 of FIG. 4 utilizing a portion of map 510 of FIG. 5.

FIGS. 7A, 7B, and 7C are illustrations of further examples of the map 510 of FIG. 5, showing an example of yet another implementation the animated travel record (“ATR”) referred to in block 420 of FIG. 4.

FIG. 8 is a block diagram of an example of another implementation of an ADS wherein multiple electronic devices may communicate with each other either through a PAS or peer-to-peer in accordance with the present invention. It is to be understood that the implementation depicted in FIG. 8 will also, in some embodiments apply to Bluetooth® and near field communication data swaps between two devices, such as “smartphones” that are in sufficient proximity to each other to effectuate such data sharing. It is also to be understood that such sharing of information by and between devices is not limited to two devices and that in some embodiments of the invention such sharing of information for purposes of effectuating the one or more embodiments of this invention may be accomplished by and between a plurality of user-devices, such as smartphones, greater than two. Further it is also to be understood that the implementation depicted in FIG. 8 could also be between a user's device and a remote computer on which the data appurtenant to other users to be shared resides. In some embodiments, such a remote computer may contain data pertaining to more than two other users, such as for thousands of members of an online dating service.

### DETAILED DESCRIPTION OF THE INVENTION

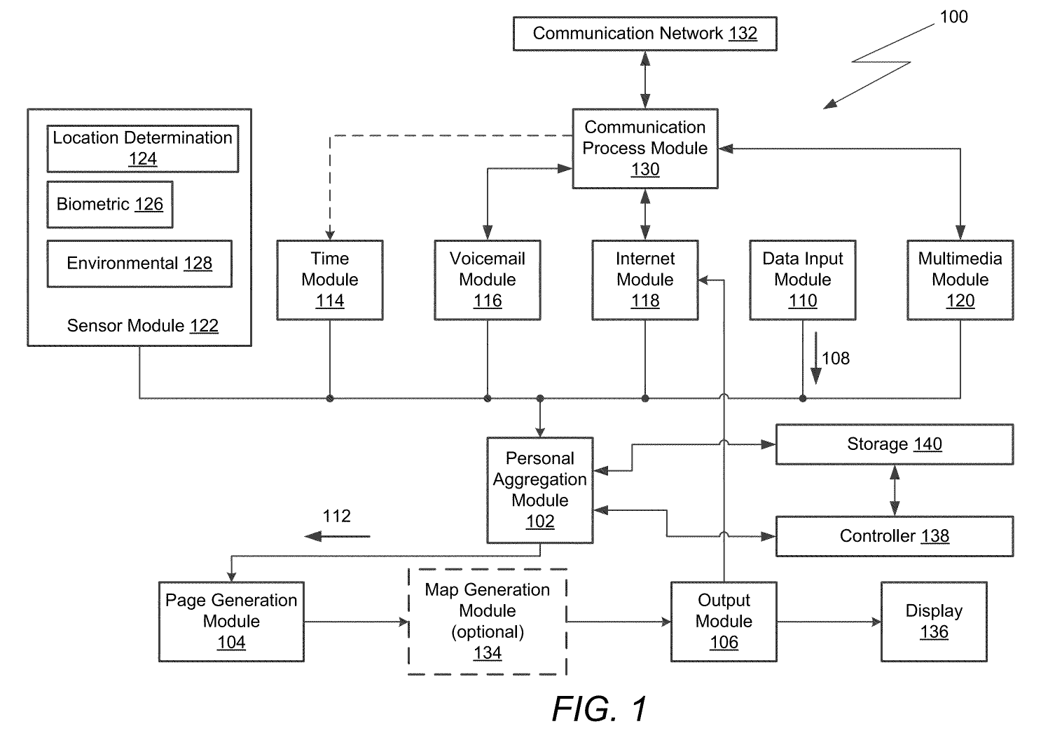

In general, a system and method for producing a diary on an electronic device is described. Turning to FIG. 1, a block diagram of an example of an implementation of an Automatic Diary System (“ADS”) 100 for use in an electronic device, in accordance with the present invention, is shown. The ADS 100 may include a personal aggregation module 102, a page generation module 104, and an output module 106. The personal aggregation module 102 may be configured to receive input data 108 from data input module 110 and at least a second module and, in response, produce aggregation data 112. The second module may be a time module 114, voicemail module 116, Internet module 118, multimedia module 120, and sensor module 122.

The personal aggregation module 102 is a device or hardware/software module capable of merging and/or fusing data received from the input data 108 and other data received from a plurality of modules that may include time module 114, voicemail module 116, Internet module 118, multimedia module 120, and sensor module 122. It should be understood that the modules providing data to be aggregated for use in the production of the ADS may be as varied in nature at the types of Data Files that may be aggregated. The data input module 110 may be any input device on the electronic device capable of receiving input information from a user such as, for example, a touchscreen, touchpads, keyboard, video and still cameras, microphone, etc.

The sensor module 122 may include a location determination sensor 124, biometric sensor 126, and environmental sensor 128. The location determination sensor 124 may be a fully functional GPS receiver that includes a location determination module (not shown) or a GPS tracker not including a location determination module. The location determination sensor 124 may also include a non-GPS location system that may include, for example, dead reckoning technology, cell tower triangulation, URL look-up, or location mapping technologies. The biometric sensor 126 may be a heart rate monitor, an exercise sensor such as, for example a Nike+IPod® sensor, alcohol detection sensor, or other similar types of sensors. The environmental sensor 128 may include a thermometer, an accelerometer, a humidity sensor, noise sensors, motion sensors, etc. In some embodiments, the sensor may be a means of detecting and/or determining if a particular person or device is in the locational proximity of the user's device, such as by detection of an identification code or other identifying data associated with another person's phone or other device by blue tooth, near field or other digital communication means.

The electronic device may be a telecommunication device that includes a communication process (“C/P”) module 130 configured to establish communication with a communication network 132. Examples of the communication network 132 may be a cellular telephone network if the telecommunication device is a cellular telephone (such as a smartphone). The C/P module 130 may be in signal communication with voicemail module 116, Internet module 118, multimedia module 120, and time module 114.

The page generation module 104 is in signal communication with the personal aggregation module 102 and an optional map generation module 134. The page generation module 104 may be configured to create an electronic page of organized data in response to receiving the aggregation data 112 from the personal aggregation module 102. The map generation module 134 may organize the electronic page of organized data into a new electronic page where the data is organized in way that includes visual geolocation data.

The output module 106 is in signal communication with the page generation module 104 (possibly through the option map generation module 134). The output module may be configured to either display the electronic page of organized data on a display 136 or to send the electronic page of organized data to an Internet module 118 that is configured to transmit the electronic page of organized data to the Internet (not shown) via the communication network 132

The ADS 100 may also include a controller 138 and storage 140. The controller 138 may be in signal communication with the personal aggregation module 102, storage 140, time module 114, voicemail module 116, Internet module 118, input module 110, multimedia module 120, sensor module 122, page generation module 104, map generation module 134, output module 106, display 136, and C/P 130. The controller 138 includes a processor that may include resident software. The controller 138 may include a microcontroller, microprocessor, general processor, a digital signal processor (“DSP”), application specific integrated circuit (“ASIC”), reduced instruction set (“RISK”) processor, or other equivalent device. The storage 140 may include one or more memory modules (not shown) such as random access memory (“RAM”) or read only memory (“ROM”).

The personal aggregation module 102 may be a module or device physically located on the electronic device that, in some instances, does not need to communicate with any external devices. Alternatively, the personal aggregation module 102 may be a module or device that calls on an external device/module to fuse the data received from the different modules. As an example, the personal aggregation module 102 may function in combination with a personal aggregation site (not shown) that is located remotely from the electronic device via the Internet. The personal aggregation module 102 may be a smartphone (or smart tablet) software application such as, for example, an “app” for an IPhone®, IPad®, Android® device, and Microsoft Mobile device. The personal aggregation module may be resident on the user's electronic device or accessible via the user's electronic device from a remote computer or network, such as a cloud computing network.

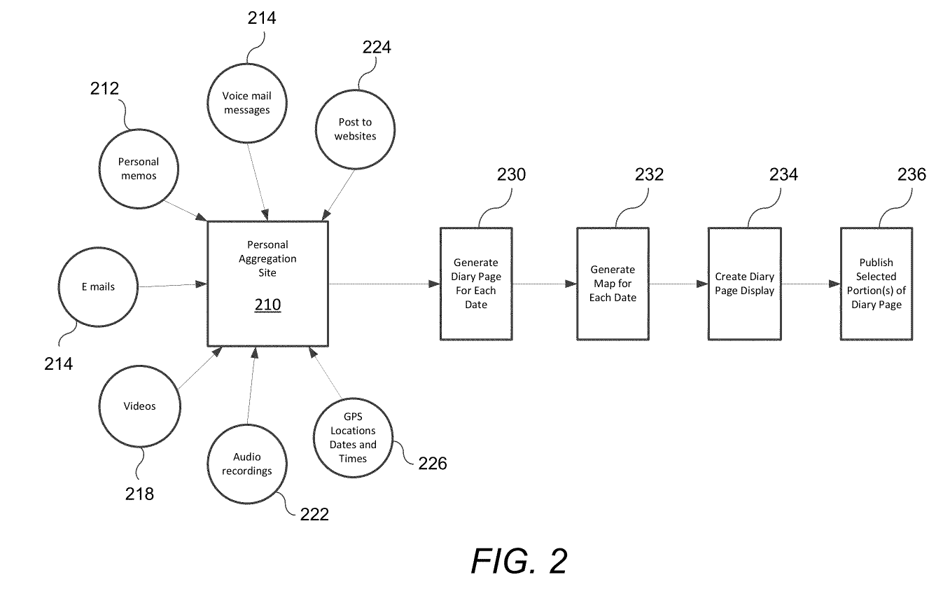

Referring to FIG. 2, a user may employ a smartphone or other personal telecommunication device to generate one or more data files (“PRDF's”). These data files can include personal memos 212, e-mail 214 and voice-mail messages 216, videos 218, still photos (not shown), audio recordings 222, text files posted on sites on a network 224, and any other file comprising digital information, such as a digital file wherein data pertaining to a product purchase is included, video voicemail files, Web surfing data files, files recording search engine searches performed, haptic data files, etc. In particular embodiments, each PRDF may also include information defining the time and the location 226 (e.g., GPS coordinates) of the site at which the PRDF was produced. Additionally, location information (e.g., GPS coordinates) can be generated separately, either periodically or at specified or random times. In some embodiments, the PRDF's, and optional separate location information, are provided by the user, using the smartphone or other personal telecommunication devices, to a site on a network, such as the Internet (the “Personal Aggregation Site”, or PAS). The PAS 210 can be, for example, a site on a network maintained by an organization that offers its members data aggregation services as described herein, including in particular the production of digital diary or “scrap-book” pages made available to the user, e.g., on a diary website. In some embodiments, PAS 210 can be, for example, a site on a network maintained by an organization that offers its members data aggregation services comprising the production of “animated travel records” diary (discussed further below).

It is to be understood that in some instances, the data comprising one or more PRDFs can be created on or otherwise be resident on one or more third party computers (such as on servers) and such data may be accessed or retrieved by the ADS as needed to produce a diary via ADS. For example, if an animated playback of a specific online diary period that includes one or more voice mail messages which can be played by clicking on the balloon notice associated in the online diary display with a specific time and place of receipt of such message, the system might only have to include instructions to retrieve the message from the user's phone service provider's voice mail server, i.e., a copy of the voice mail message itself need not be on the user's device. In this way storage space on the user's device may conserved, etc.

Therefore, in some embodiments, the ADS system may acquire data from many sources to generate the diary display from the aggregation of data from a plurality of data sources (e.g., the interactive map where the different types of data pop up at various locations associated with their creation, etc.). Thus, the data used by the ADS may be (1) resident on other servers, (2) resident on the user's electronic device, (3) copied from a remote computer onto the user's electronic device, or (4) a combination of (1), (2), and/or (3).

In some instances the data to be used in assembling an online diary by the ADS may be recorded and stored on the user's electronic device or on a remote device effectuating an ADS application (e.g., in a cloud network). To effectuate this type of data recordation an application or other program may, in some instances be triggered by the user, or automatically by the ADS, at some point prior to the aggregation of the data for use in the ADS's assembly of an online diary. For example, an application that makes a recording or other copy of voice messages that are stored on a phone service provider's voice mail server may be used to make a copy of voice mails to be included in the aggregated data for use by the ADS. For example, if a user has a voice mail message that is stored on a phone service provider's voice mail server, a recording application can be used to make a copy of a voice mail message at the time a user plays it. In some embodiments of such an application, the user can be asked if he or she would like to make a copy of the voice mail message for storage on the user's device (or on another device, e.g., in a cloud network) for use by the ADS. In some embodiments of such an application, the digital file on the telephone service provider's voice mail server is accessed through the use of the application which, after accessing the subject voice mail data file, copies the data file on to the user's electronic device (or on another device, e.g., in a cloud network).

In some embodiments, such as where access to the phone company's voice mail server is not available because, for example, doing so is not practical, is not allowed by the company, or is prohibited by law, the recording methodology whereby a recording application is used to record the message as it plays and a digital file of the recording is made available for use by the ADS's aggregator function, may be used.

It should be understood that similar types of applications may easily be developed by persons skilled in the art regarding the accessing and acquisition of any type of data that is desired to be aggregated by the ADS that must be retrieved (e.g., from a remote server) and/or copied for aggregated use in the ADS (e.g., data regarding personal memoranda, e-mail and voice-mail messages, videos, photos, audio recordings, notes, texts, tweets, Web pages, Internet search results, online payment information, information about products and services, purchased, tickets, coupons, data regarding redeemed tickets, data regarding redeemed coupons, maps and other data associated with the user's present or past location, data associated with the playing of games (e.g., online games), data that the user has inputted on Web sites, data associated with the user's Web browsing (e.g., cookies, etc.), data regarding phone calls the user has made and received, recordings of voice mail messages, recordings of video mail messages, and data associated with haptic information created or received by the user, etc.). For example, creation of applications to access and retrieve (and/or copy) remotely stored data, such as voice mail messages, email messages, or web browsing data, is well known in the art.

Once the PAS 210 receives the user's PRDF(s), the PAS 210 aggregates the data so provided into a Diary File (“DF”). The DF, in particular embodiments, is displayed in a “scrap-book” or “diary” format (234) (for an example of such a display, see FIG. 5). In some preferred embodiments the DF may be displayed in a form that provides a display of an animated travel record as discussed below.

A separate DF is generated for each individual date (or other selected time increment) (230), and all PRDF's generated on a given date (or other time increment) are collected and displayed on the same page. Lists of PRDF's, sorted by type, are generated and displayed on the DF in particular embodiments.

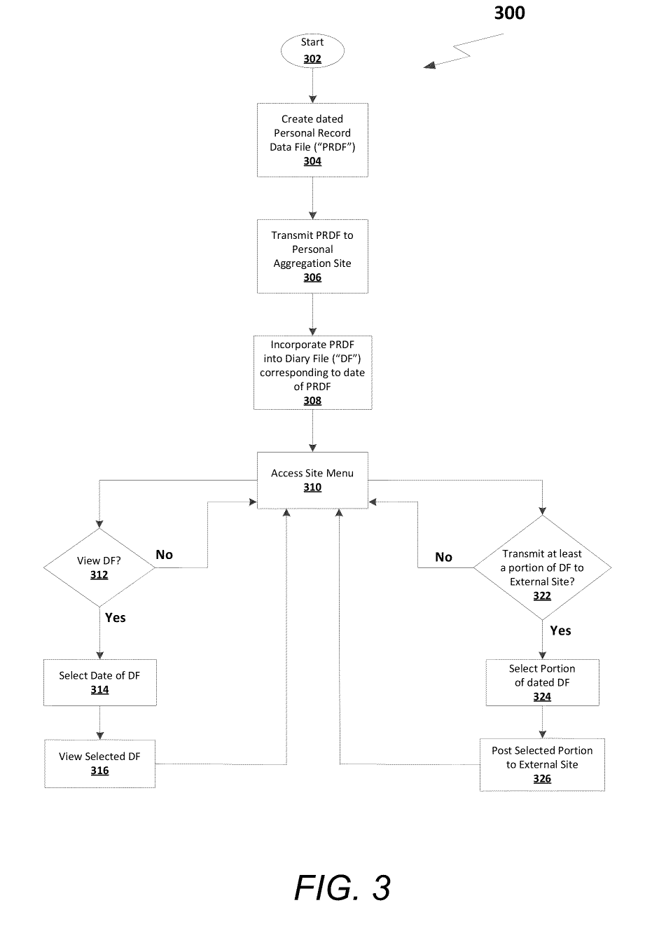

In additional embodiments, the PAS 210 generates a map (232) showing the locations at which the user was present during the date or other selected time frame for which the DF is generated. Such a map can be a still map, or in more particular embodiments, can include a moving icon depicting the travels of the user along the illustrated path during the date of the DF. The PAS 210 may also create a diary page display (234) and publish portions of a diary page (236), as further explained in FIG. 3.

Turning to FIG. 3, a flowchart illustrating an example of an implementation of a method of the present invention in which PRDF's are created, transmitted to a PAS, and combined into a single DF for a specified date is shown. The method (or process) starts in step 302, and in step 304, the user creates a dated PRDF using an electronic device. In step 306, the user transmits the PRDF to a Personal Aggregation Site, such as the PAS 210 of FIG. 2.

At the PAS, the PRDF is incorporated into a dated DF in step 308. In step 310, at an Access Site Menu (which may be a menu maintained by the PAS, or alternatively, on the DF for the selected date), the user is given several options regarding dated DF's. In decision step 312, the user is asked if he wishes to view a DF. If he does not wish to do so, the process returns to step 310. Otherwise, the user is able to select a date of a DF in step 314, and in step 316, the user is able to view the selected DF Likewise, in decision step 322, the user is asked if he wishes to transmit a portion of a DF to an external site, i.e., an external site on a network accessible from the PAS (for example, a social network site, a blog, or any other site that allows posting of user content). In step 324, the user selects a portion of the selected DF, and in step 326, the selected portions are thus published to the selected external site.

Such embodiments afford the user enhanced control over the publication of his or her content, by providing the user with the DF (including the data files generated on the selected date) prior to their appearance on another website. The user can thus prevent publication of content that he or she desires to keep private.

In some embodiments a plurality of DFs of different users may be compared and analyzed to determine commonalities which may be displayed as one or more new DFs to such users.

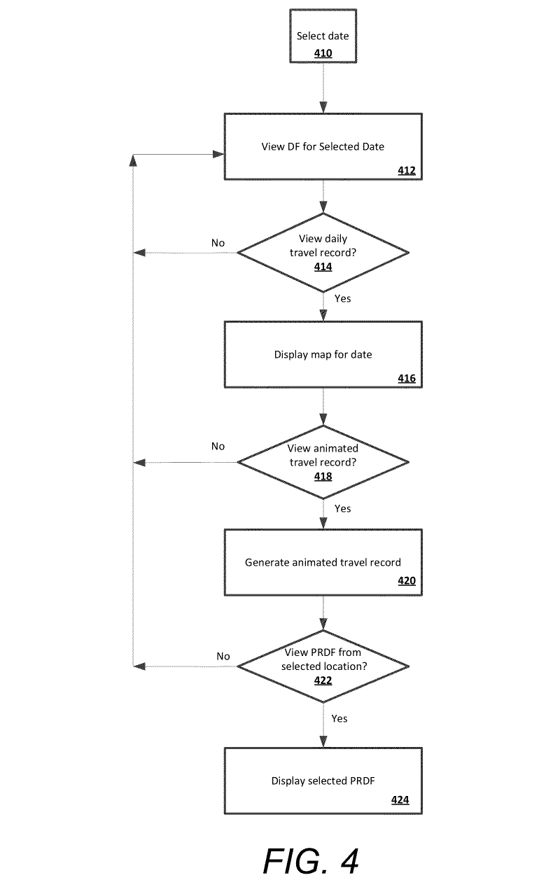

In FIG. 4, another flowchart is shown, which illustrates additional options that may be available to a user of an ADS. In step 410, a user, while accessing, for example, the Access Site Menu 310 of FIG. 3, selects a date of a certain DF he wishes to view, and in step 412, the corresponding DF is retrieved and displayed to the user. In decision step 414, the user is asked if he wishes to view a map showing the locations at which the user was present as shown in the selected DF. If the user answers “Yes,” then in step 416, a still map is generated on a display for the user. An example of such a map is shown as Map 510 of FIG. 5.

In step 418, the user is given the option to view an animated travel record, whereby a moving dot or other indicator appears on a map, satellite picture, map/satellite picture combination, or similar type of graphic generated by ADS corresponding to the locations where the user has been located during the day or other selected time period. The user's movements during the day or other selected time period that are ascertained by use of the location detection means incorporated into the user's device are reflected in the display as a moving icon, such as a dot, that moves on the displayed map, satellite picture, map/satellite picture combination or similar type of graphic generated by ADS in correspondence with the user's movement from location to location during the day or other selected time period. If the user wishes to view this feature, the animated travel record (“ATR”) is displayed to the user in step 420.

In step 418, the user is further given the option to view PRDF's related to each location along the animated travel record. For each PRDF selected at a location, the PRDF is displayed in step 424. Examples of such displays are shown in more detail in FIG. 5.

FIG. 5 shows an example of a display of a DF that may be displayed to a user, on an electronic device, such as Display 136 of FIG. 1. Map 510, which may be generated by the optional Map Generation Module 134 of FIG. 1, shows the locations at which the user was present during the selected date (or other specified time) for which the DF is generated. Such a map can be a still map, or in more particular embodiments, can also include a moving dot or other indicator depicting the travels of the user along the illustrated path during the date of the DF.

As an example, the animated travel record shown at block 420 of FIG. 4 may begin at dot 512, which indicates the location of the user at 10:00 a.m. on the date of the DF. Other dots appear on a route shown on the map 510, where the route terminates at dot 514, which indicates the location of the user at 10:00 p.m. on the date of the DF.

Additionally, one or more icons may be displayed on the map 510 that correspond to one or more of the PRDF's aggregated by the ADS. These icons may be displayed on the map at each location at which the PRDF's were generated. As an example, at dot 516, icons representing audio, photos, videos, and personal memos appear, which correspond to icons 532, 528, 526, and 522, respectively. Additional icons 524, 530, and 534 may also appear, for e-mails, voice mails, and posts to Web sites, respectively.

Thus, while the dot moves, interactive graphical pop-ups, bubbles or other indicia appear indicating where a photograph or video was taken or received by the user, where a text was sent or received by the user, where an item was purchased by the user, where a song was downloaded, where a website was viewed on the phone, where a friend was encountered and the phone registered the interaction (by Bluetooth recognition of the friend's phone, etc.).

Thus, in this particular embodiment, the user is afforded the option to access one or more of the PRDF's generated at dot 516, for example, by clicking on the desired icon. Thus, as shown in FIG. 5, the user can activate the “My Videos” icon at the point on the map denoted “12:30 pm”, and view the video she created or received at that time and location. Such features allow the user to “re-live” the date of the DF and the activities in which she engaged on that date.

Similarly, in some embodiments, the user is afforded the option of selecting only certain types of PDRFs for retrieval in association with the animated travel record or other DF.

In some embodiments, the user can click on icons that appear as pop-ups, bubbles or other graphical indicia to see the specified photograph, text, tweet, etc., play the specified video, voice message or game online game-play segment, access the specified website or search engine search, or feel the specified haptic data sent or received, etc.

This feature provides the user with the ability as he or she “plays” an animated digital representation of the user's digital profile aggregated in the ADS corresponding to a particular time period in the user's life to relive to an extent the user's life in regard to the user's aggregated digitally-recorded life events.

Additionally, in other embodiments, a moving icon could provide a moving picture representation of where the user has been over any particular time frame other than a single day, such as a week, a month, etc., that is, for any time frame t. In this particular embodiment, a dot or other indicator moves along a route shown on the map 510, and at each location along the route where a PRDF was generated, a pop-up icon or other indicia appears to indicate where a picture or video was taken, where a text was sent, where an item was purchased, etc. In additional to allowing the user to select the time period to be displayed, the ADS may also allow the user to control the pace at which the route is retraced on the map 510 (e.g., one day per minute, one day per second, etc.). In some instances, the DF displays a clock or other chronometer that displays the time at which the user was at the location displayed.

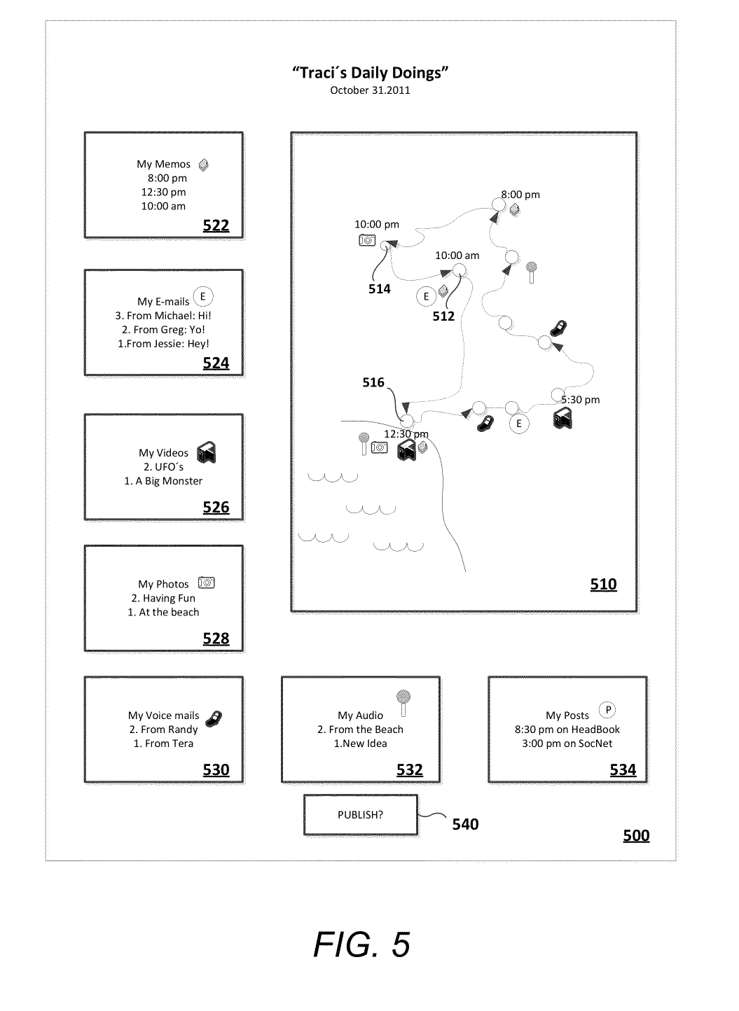

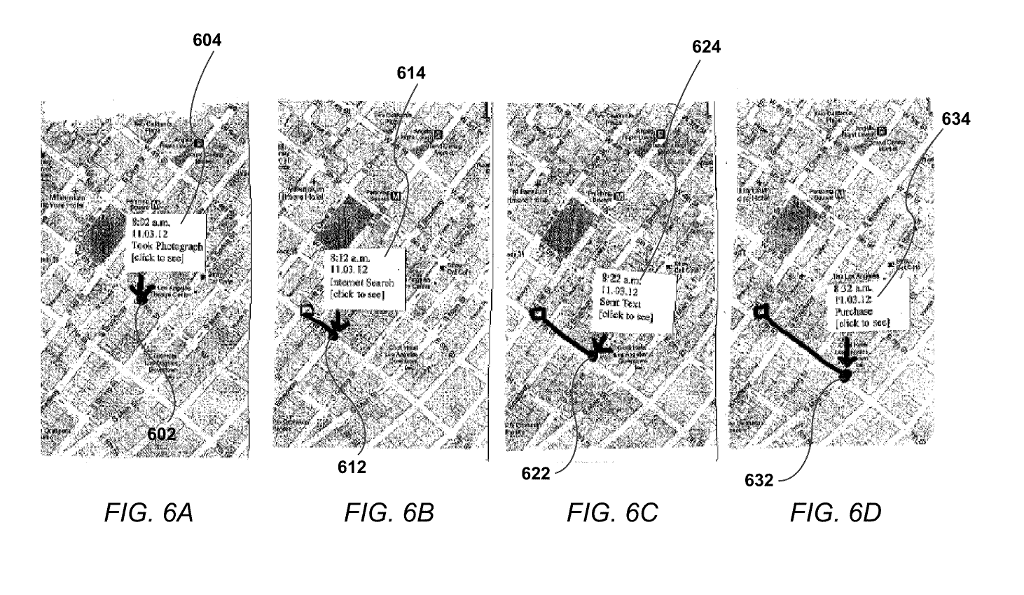

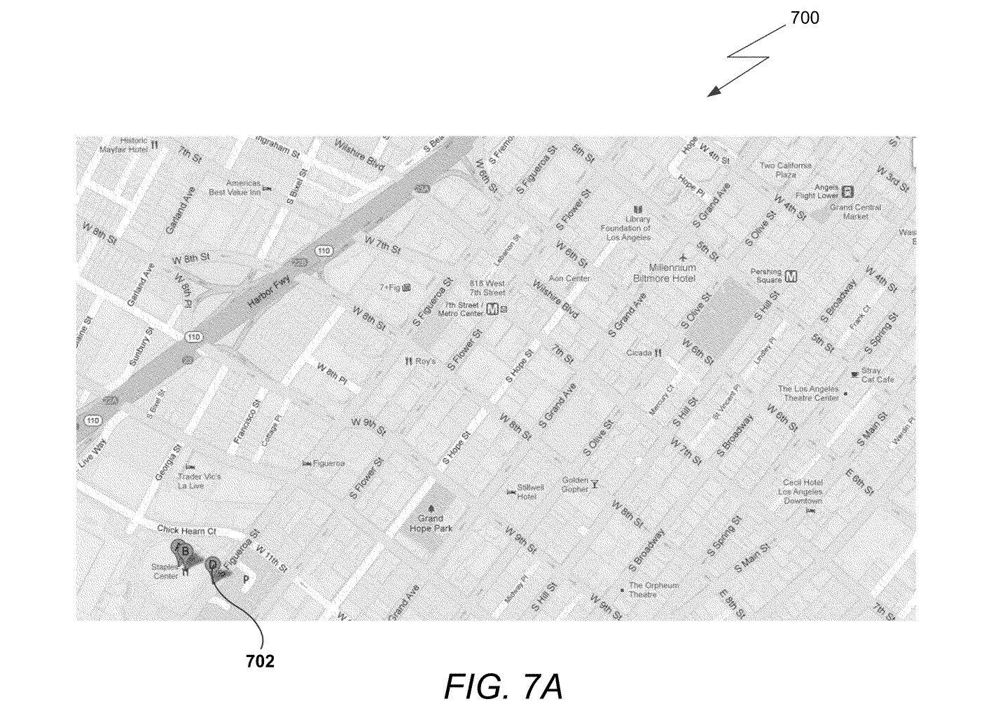

An example of such an embodiment is illustrated by FIGS. 6A, 6B, 6C, and 6D. In general, the four figures if FIG. 6 illustrate four points in time of a continuation animation, i.e., the animated travel record (“ATR”) of block 420 of FIG. 4, that plays on a user's electronic device over a predetermined period of time, which for the ATR illustrated in FIG. 6, may be 30 seconds. FIG. 6 therefore depicts what may be analogized to the display of selected frames of a movie. In the instant case, FIG. 6 depicts a part of an ATR being “played back” by a user. In FIG. 6 the pop-up notes regarding PDRF data in the ADS are displayed momentarily. In some embodiments, all the notations displayed by the DF in ATR mode remain on the user's display.

In FIG. 6A, the 30-second ATR starts at point 602, where popup text block 604 informs the user that on a certain date, he or she took a photograph at point 602, and the user is given the option to retrieve and view this photograph from his aggregated electronic data in the ADS by clicking on the interactive notation which functions as a hyperlink to the data referred to in the note (“8:02 a.m. 11.03.12 Took Photograph Click to see”). In FIG. 6b, the next frame in the ATR is shown, which shows another event occurring 10 minutes after the event depicted in FIG. 6A corresponding to the time when the user moved to the location depicted on the map display (“8:12 a.m. 11.03.12 Internet Search Click to see”). In this instance, the user conducted an Internet search at point 612, which is disclosed in popup text block 614, and likewise, the user is given the option to retrieve and view results of this Internet search. It is to be understood that if the user in the instant example had accessed a web page at the depicted location, and the URL for the web page was stored as a part of the user's ADS data for the subject DF, the note would have indicated user had accessed a web page at that time and place and would have provided the user with an interactive notation, which, if clicked, would cause the user's phone to display the same web page previously accessed when the user was at that place and time.

Turning to FIGS. 6C and 6D, the following two frames of the 30-second ATR are shown. In FIG. 6C, the user sent text message at point 622, which is disclosed in popup text block 624 (“8:22 a.m. 11.03.12 Sent text Click to see”), and the user is able to retrieve this text message if he or she so desires by clicking on the interactive notation displayed. As with other interactive notations described herein, the interactive notation is a hyperlink (or similar type of engageable link) which, when clicked will cause the user's device to retrieve and display the data referred to in the interactive notation. In FIG. 6D, the last event of the 30-second ATR is shown, wherein the user has made a purchase at point 632, which is noted in popup text block 634 (“8:32 a.m. 11.03.12 Purchase Click to see”). If the interactive notation depicted in FIG. 6D is clicked, purchase information stored in the ATR (or remotely) is accessed and displayed on the user's device.

For the purpose of understanding the concept depicted in FIGS. 6A-6D, a 30-second time frame is suggested. But it is to be understood that in some embodiments, the time frame in which an ATR covering a selected DF time period (1 day, 2 weeks, 3 month, 4 years, etc.) may be played back on a user's device at a speed selected by the user. In this way the user may, for example play one day's worth of a DF ATR in one year's in one minute. In some embodiments the playback rate and speed is set by a provider of the ATR. Therefore, it is understood that in some embodiments, any time interval may be chosen by a user, and that the events and data displayed may occur at any time within a selected diary time period and the playing of the ATR and associated events indicated by the associated interactive notations are displayed automatically once the desired time period is determined.

In some embodiments two or more ATRs of the same or different users, or one or more parts thereof, may be overlaid or otherwise combined to produce one or more playable combined ATRs. Additionally, in some embodiments the animation of one user may be overlaid, combined, and played simultaneously with the animation for another with respect to a segment of their respective and combined DFs that shows paths to and/or from one or more points of commonality.

A plurality of users' ATRs may be combined and played simultaneously. In some instances, the number could be large where hundreds, thousands or potentially millions of users ATRs are combined and played to reveal, for example, points of commonality and/or patterns of activity leading to points of commonality (e.g., common location at the same time, common location at different times, etc.). A combination of a number of user's ATRs may be configured and used in some embodiments to display or otherwise reveal certain actions taken (e.g., travel paths, restaurants visited, message leaving or retrieving behavior, purchasing behavior, etc.) that can provide valuable demographic information regarding the users and/or a population segment. The combined ATR feature may be considered to be one of the “commonality” features of the invention and it is to be understood that one or more commonality features and/or functions described may be applied in one or more combination ATRs and/or the results produced from such combination ATRs.

It is to be understood that while in some embodiments each user may view one or more ATR animation combining of two or more users simultaneously, in some other embodiments each user need not view the combined ATR simultaneously.

The popup text blocks shown in FIGS. 6A-6D indicate certain actions that were taken by a user at the relevant site at the times noted. It is also understood that these popup text blocks may include or trigger the display of advertisements, coupons, notices or other communications that are related to event described in the text block. For example, an advertisement associated with the topic of the Internet search described in popup text block 614 may commence to be displayed on the user's phone at that time in the ATR. In other embodiments the advertisement may only be displayed if the user clicks on the note to see the results of the Internet search, or in other embodiments, the advertisements may be displayed momentarily (so as to not disturb the aesthetics of the animation) and in yet other embodiments, the advertisements may remain on the display (say, off to one side). In general, any such advertising may be effectuated in association with a Web site visitation recordation in the DF, or in association with any other kind of PDRF that is associated with the playing of the ATR.

In some embodiments, the “playback” of the DF can be combined or overlaid with commonality points and event data corresponding to one or more other persons' DF(s). This feature of the ADS enables a user to “play” a specified DF or part thereof that will appear to the user as a plurality of dots corresponding to the various users that move along the map or other graphic in correspondence with time t.

In some preferred embodiments of the invention, advertisements, electronic coupons, notices, and other communications may be associated with data aggregated by the ADS and displayed to one or more users of the ADS. For example, in some embodiments, such advertisements, electronic coupons, notices and other communications are associated with data used to generate the ATR. In some preferred embodiments, advertisements, etc., are associated with one or more PRDFs, one or more locations corresponding to points on the ATR map, one or more locations where the user was presumed to be located (because of the location of the user's device for which locational information was provided to the ADS and/or any combination of the foregoing. In some embodiments of the invention, advertisements, coupons and/or other communications pertaining to, for example, one or more business establishments located at one or more points nearby one or more locations corresponding to user location data provided to the ADS by the user's electronic device, are provided to the user via display on the user's device. In some other embodiments, the advertisements, coupons, and other communications are retrieved from a storage on a computer (e.g., files loaded into the user's device or accessed from another party's computer) and displayed in association with points on the ATR map or with icons associated with one or more PDRFs that are displayed on the ATR map. In some preferred embodiments such retrieved advertisements, coupons or other communications are displayed elsewhere on the user's device.

For example, while a ADS user is playing back an ATR, if the “dot” corresponding to the user's location showed that the user was at a McDonalds restaurant on Jan. 18, 2013, at 2:03, which was at a location corresponding to a part of the map or other graphic displayed as a part of the ATR, a popup or other associated graphic, video, or other communication might display a McDonald's coupon or other advertisement, or a competitor's advertisement or a communication related to the event depiction at the ATR. Such communication may be, for example, a coupon for a McDonalds product, an advertisement for a competitor's product, a news story regarding fast food, a Weight Watcher's® coupon, or a user-generated note to self such as “I gotta stop eating this stuff”, etc.

In another example, the display of advertising or one or more other communications to the user is associated with an action taken by a user at a particular location that generated a PDRF. For example, while the user is playing an ATR, a pop-up icon advertisement or other communication associated with a business establishment, such as a Starbucks® café, at which the user purchased a product during the time covered by the ATR, for which transaction a digital file was created and aggregated into the data used by the ADS (for example, if the transaction was effectuated using the user's smartphone equipped with payment means that utilizes near-field communication technology and data regarding the transaction was stored on the user's electronic device), is displayed on the user's electronic device. In some embodiments, the advertisement may be associated with a PDRF comprising a video taken or received by the user at the business establishment location. In some preferred embodiments, as the ATR is “played” and the dot on the ATR map corresponding to the user's location moves close to, or in some embodiments, arrives at, the area of the map corresponding to the location of the business establishment, a pop up advertisement inviting the user to re-visit the establishment may be displayed in the ATR and/or elsewhere on the user's device. For example, in some preferred embodiments, a message could then be displayed in the ATR display or elsewhere on the user's electronic device such as “Greg, we haven't seen you at the Starbucks® at First Street and Main Street for 74 days, here's an electronic coupon for a free Mocha Grande redeemable at our location during the next thirty days.” In some preferred embodiments, an electronic coupon associated with the offer is provided to the user's phone or other device.

It is to be understood that geo-targeted or ATR data related delivery of advertising or other communications on, and/or the providing of one or more electronic coupons to, the user's electronic device, should not be viewed as the exclusive means of associating and displaying advertising associated with specific data used to generate one or more ATRs. In some embodiments of the invention, advertising and/or other communications displayed on, and/or the providing of one or more electronic coupons to, the user's electronic device, may be associated with and/or triggered by other data aggregated in the ADS. For example, in some embodiments of the invention, use of the ADS to retrieve data associated with a DF, such as an photo, video, email, text or tweet created, sent or received by the user during the period covered by the DF, or to display a Web site visited by the user during the time period covered by a DF, triggers the retrieval and display of a predetermined advertisement or other communication that is locationally, thematically, or otherwise associated with the data retrieved.

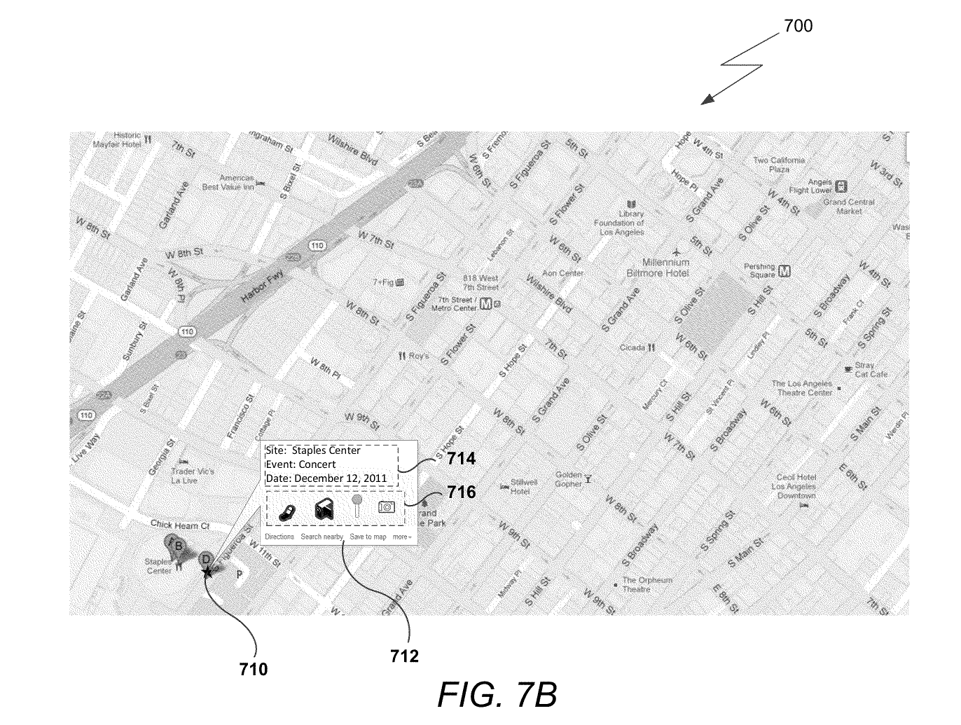

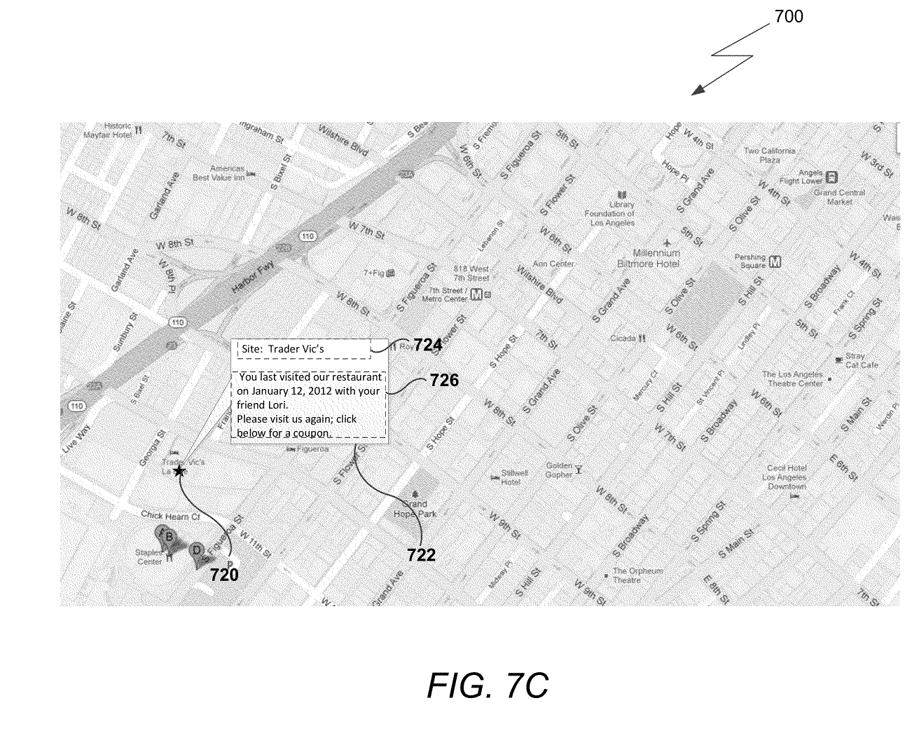

In some embodiments of the invention, a user can use the data used to create an ATR to enable the user to call up on the user's device places he or she has been, and PDRFs created at such places, in association with the retrieval of a map or similar graphic depicting locations at which the ADS has stored information. An example of this reminder of places the user has been to in the past feature is shown in FIGS. 7A, 7B, and 7C. FIG. 7A shoes a Google® map 700 that covers a portion of Los Angeles, Calif. Shown on map 700, among numerous points of interest, is the Staples Center, indicated by balloon D (702). Additionally, there are several restaurants, hotels, theaters, etc.

In the animated travel record (“ATR”) mode referred to in block 420 of FIG. 4, the user is enabled to move a dot or other indicator over the map 700, using, for example, a mouse or a touchpad, and when the indicator “hits” a location on the map that relates to anything in the aggregated electronic information in the online diary, a balloon or other graphic will appear informing the user of the relevant information. In FIG. 7B, the indicator is a star 710, which when placed over balloon D causes a balloon 612 to appear. Within balloon 712, there is information 614 related to an event the user recently attended. Additionally, balloon 612 may contains icons 616, which allow the user to retrieve related PRDF's as shown in FIG. 5.

In FIG. 7C, the user moves star 720 to a nearby restaurant and because the user has previously entered a PRDF related to this site, balloon 722 appears, informing the user of that he or she has visited the restaurant in the past. Balloon 722 may also contain information provided by the business establishment, as well as coupons and other inducement s to the user to return to the business establishment.

Additional features enable the user to publish some or all of the PRDF's displayed on the DF for a selected date (see blocks 324 and 326 of FIG. 3). Thus, in this particular embodiment, the user accesses a menu maintained by the PAS (or alternatively, on the DF for the selected date). The user then selects the “Publish” option by activating icon 540, at which point she is enabled to select one or more PRDF's listed on the DF (or, in further particular embodiments, portions of such PRDF's). Once one or more PRDF's have been selected, the user is then enabled to transmit the selected files to an external site on a network accessible from the PAS (for example, a social network site, a blog, or any other site that allows posting of user content). The selected PRDF's are thus published to the selected external site.

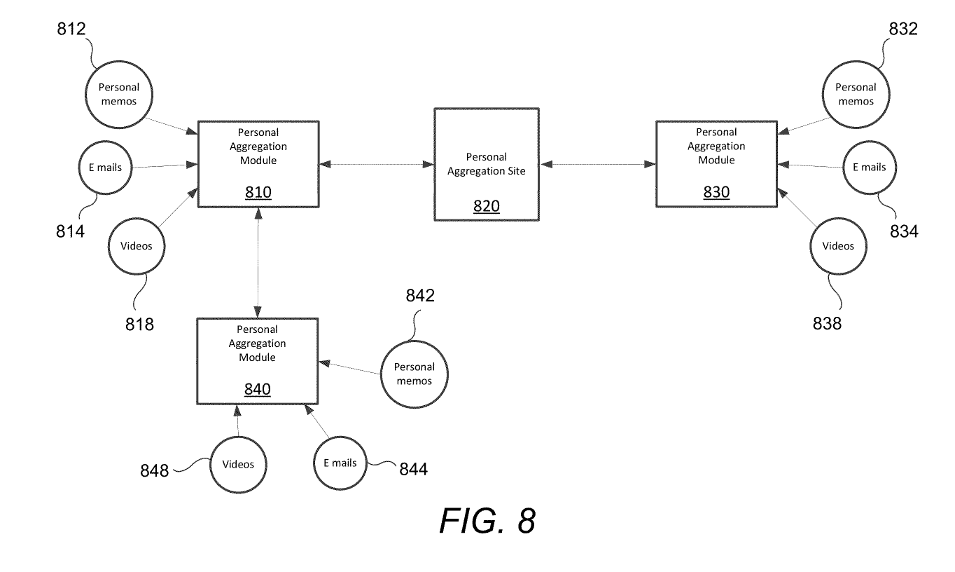

Turning FIG. 8, a block diagram show an ADS comprising multiple electronic devices that may communicate with each other through a PAS or directly with each other. As in FIGS. 2 and 3, in FIG. 8, personal aggregation module 610 may be a module or device physically located on an electronic device that does not need to communicate with any external devices, that generates one or more data files (“PRDF's”). These data files may include personal memos 812, e-mail 814 and videos 818, as well as the other data files shown in FIG. 2 and any other file comprising digital information. Likewise, personal aggregation module 830 is a similar ADS operated by a different user, e.g., User B, whereas personal aggregation module 810 is available to User A.

Both personal aggregation modules 810 and 830 are in signal communication with PAS 820 and therefore have the capabilities shown in FIGS. 3-5. Additionally, the ADS may be configured to determine commonalities between the PRDF's of User A and User B. For example, where User A visited a location and took photos, or attended a concert, and that information is contained in a PRDF of User A, the ADS can match that particular event or occasion with the same or similar events or occasions that appear in the PRDF's of other users by comparison of all PRDF's in the PAS. Such comparisons may be initiated by User A, for example, who makes a search and compares of his or her PRDF data (or selected parts thereof) with other online submissions. In other implementations, a user may consent to making his or her PRDF data available online to allow other users to make their own commonality determinations or even request or solicit responses to specific PRDF data.

In another implementation, personal aggregation modules 810 and 840 are in direct signal communication with each other. With this implementation, two or more users who each have information aggregated in an ADS in the form of PRDF's connect their electronic devices, e.g., smart phones, next to each other and initiate a diary comparison feature that allows the ADS to determine any commonality of the two users, such as places visited, movies or concerts attended, etc. at some time in the past.

In some preferred embodiments of the invention, the commonality features described can be used by more than just two users. For example, a user may provide to a dating or matchmaking Web site his or her PRDF, or other ADS, data for comparison with PRDF, or other ADS, data provided by one or more members of the dating or matchmaking Web site. All or part of the aggregated PRDF data, and/or other data used by the ADS, may be provided to such an online dating or matchmaking service where such data is compared by one or more computers to facilitate the determination of commonalities between users. Examples of commonalities that could be determined via such data comparison means include places that user's were present at the same time, places that the users were present at different times, and specific events or types of similar events the users attended, at the same time or at different times.

In some embodiments, some or all of the results of the comparison of PRDF data in different users' DFs, and/or other ADS data, can be shared by or among the users.

In some embodiments of the invention, the determining and sharing of the commonality of the PRDF data in the ADS is limited by the interests of the users who select the factors that are important or relevant to them, and thus may relate to any information that is stored in the PRDF's submitted and may cover any time period. Additionally, this feature of determining and sharing may be used by third party commercial interests in targeting advertising and other solicitations to specific groups of consumers.

In some preferred embodiments of the invention, advertising is provided to a plurality of users using one or more of the commonality features of the ADS in association with one another. For example, when one or more of the commonality features are used by two or more persons in association with one another, such as, for example, when the commonality data point generated is the location of a store or some other predetermined place or event type, the ADS may be configured to provide one or more advertisements, coupons, notices, and/or other communications that are displayed and/or delivered to such plurality of users' respective electronic devices. This could be very useful if a person is using the ADS in conjunction with a dating or matchmaking site. For example, in some embodiments of the invention, a male user of the ADS can provide to a dating or matchmaking website his or her aggregated ADS data, or subset thereof, for comparison with similar data provided by females that have made their aggregated ADS data available for such commonality determinations. If, for example, the result of the providing of such data to the ADS, and the use of the commonality determining feature of the invention reveals to a male user that there is a commonality of data with one or more female members of a dating or matchmaking site with respect to the parties (the user and such female members) having previously contemporaneously been at a location corresponding to a nearby business establishment, then a predetermined coupon or other advertisement, for example, relating to that business establishment can be provided by the ADS (or by a third party having access to the ADS and/or data associated therewith) to one or more of such parties. In some embodiments, such communication may be (1) generated by the ADS system, (2) generated and sent by the establishment from a data cue provided by the ADS system, or (3) provided by a dating site member (alone or in conjunction with (1) and/or (2)).

Another example, continuing the scenario above, might be the following: if the ADS commonality feature reveals that both the male user, let's call him Greg, and a female member of the online dating or matchmaking service, let's call her Lori, have visited the same Starbucks® establishment (at the same time or within a predetermined time range), a coupon could be presented to them both. Such coupons could further a social networking experience, for example, by communicating a message such as the following: “Greg and Lori, Starbucks® would like to invite you both to come into our First and Main Street location together to receive a free Café Mocha on us”, etc. In some embodiments of the invention, such a coupon or other offer may only be redeemed if both or all of the parties to whom the offer is made do so together.

Because the use of the ADS will often likely aggregate and use personal data, in some embodiments, the ADS is configured to limit use of data for some features. For example, when a commonality determination is made, the publication or sharing among users of resultant commonality data can be restricted in whole or in part. For example, a person may not want commonality points such as attendance at a strip club, a casino, a pawn shop, or a Justin Beiber concert to be communicated to the other person or persons, or to a third party system (such as a dating site), etc. In some embodiments, the limitations used for commonality determination purposes could also be used to effectuate security and privacy protection as such types of data could be selected by the user to be blocked from publication by the ATS.

Such security features could be triggered or limited on the basis of time, location, person or entity which accesses, or seeks to access, the commonality data, etc. Advertisers, for example, could be selectively prohibited from accessing all or some of the data aggregated in the ADS that is used for generating the commonality feature(s) or the ATR feature(s), etc.

Parts of a user's information aggregated in the ADS and/or the graphics and other displays generated by its use (such as in the ATR and/or commonality features), can be used to conveniently easily populate one or more social networks participated in by the user. The user may, for example, select an option offered in the ADS to make data comprising photos and/or videos taken by the user and stored as PDRFs in the ADS, along with a copy of a part of an ATR animation leading up to and including the location and time at which such photos and videos were taken, available be placed on Facebook®, Twitter®, and/or Stage32™. Meanwhile, the same user might elect that all texts sent to a subgroup, such as to persons working in the user's company, be uploaded to a company exclusive social network. Similarly, all music events, such as concerts attended, songs purchased, music videos watched, music sites visited, and texts in which the keyword “music” was used by the user, might only be sent to a specialized musicians' social network that the user belongs to.

It will be understood that various aspects or details of the invention may be changed without departing from the scope of the invention. Furthermore, the foregoing description is for the purpose of illustration only, and not for the purpose of limitation.

What is claimed is:

1. An Automatic Diary System (“ADS”) for an electronic device comprising:
a personal aggregation module, wherein the personal aggregation module is configured to receive input data from a data input module and at least one other module and, in response, produce aggregation data, wherein the at least one other module is chosen from a group consisting of a time module, a voicemail module, an Internet module, a multimedia module, and a sensor module;
a page generation module is signal communication with the personal aggregation module, wherein the page generation module is configured to create an electronic page of organized data in response to receiving the aggregation data from the personal aggregation module; and
an output module in signal communication with the page generation module, wherein the output module is configured to either display the electronic page of organized data on a display or to send the electronic page of organized data to an Internet module that is configured to transmit the electronic page of organized data to a server via the Internet or to another electronic device.
